(19) United States
(12) Patent Application Publication
(10) Pub. No.: US 2026/0288417 A1
(43) Pub. Date: Sep. 24, 2026

(54) FINITE FIELD OPERATION DEVICE AND MEMORY SYSTEM

(71) Applicant: Kioxia Corporation, Tokyo (JP)

(72) Inventors: Takanori NAGASHIMA, Yokohama (JP); Hajime MATSUI, Yokohama (JP); Kazuki INOUE, Kamakura (JP)

(73) Assignee: Kioxia Corporation, Tokyo (JP)

(21) Appl. No.: 19/238,694

(22) Filed: Jun. 16, 2025

(30) Foreign Application Priority Data
Mar. 24, 2025 (JP) 2025-048039

(51) Int. Cl. G06F 7/72; G06F 5/01; G06F 7/50; G06F 7/523; G06F 7/544

(52) U.S. Cl. CPC G06F 7/724; G06F 5/01; G06F 7/50; G06F 7/523; G06F 7/5443

(57) ABSTRACT

According to one embodiment, a finite field operation device includes a plurality of multiplication circuits, an addition circuit, a remainder circuit, and a correction circuit. Each of the plurality of multiplication circuits is configured to multiply a first integer by a second integer. The addition circuit is configured to collectively add multiplication results of the plurality of multiplication circuits. The remainder circuit is configured to obtain an approximate value of a modulo operation result with a third integer as a modulus with respect to an addition result of the addition circuit. The correction circuit is configured to correct an error of the approximate value.

### CROSS-REFERENCE TO RELATED APPLICATIONS

This application is based upon and claims the benefit of Japanese Patent Application No. 2025-048039, filed on Mar. 24, 2025; the entire contents of which are incorporated herein by reference.

### FIELD

Embodiments described herein relate generally to a finite field operation device and a memory system.

### BACKGROUND

There is a memory system that performs processing including a finite field operation related to a digital signature. The memory system includes a device or a circuit for performing the finite field operation. In the memory system including such a device or circuit, it is desirable to perform the finite field operation at a high speed.

### BRIEF DESCRIPTION OF THE DRAWINGS

FIG. 1 is a diagram illustrating a configuration of a memory system to which a controller including a finite field operation device according to a first embodiment is applied;

FIG. 2 is a circuit diagram illustrating a schematic configuration of the finite field operation device according to the first embodiment;

FIG. 3 is a circuit diagram illustrating a detailed configuration of the finite field operation device according to the first embodiment;

FIG. 4 is a circuit diagram illustrating a schematic configuration of a finite field operation device according to a second embodiment;

FIG. 5 is a circuit diagram illustrating a detailed configuration of the finite field operation device according to the second embodiment;

FIG. 6 is a circuit diagram illustrating a schematic configuration of a finite field operation device according to a third embodiment;

FIG. 7 is a circuit diagram illustrating a detailed configuration of the finite field operation device according to the third embodiment;

FIG. 8 is a flowchart illustrating key generation processing according to a fourth embodiment;

FIG. 9 is a flowchart illustrating signature generation processing in a first modification of the fourth embodiment; and

FIG. 10 is a flowchart illustrating signature verification processing in a second modification of the fourth embodiment.

### DETAILED DESCRIPTION

In general, according to one embodiment, a finite field operation device includes a plurality of multiplication circuits, an addition circuit, a remainder circuit, and a correction circuit. Each of the plurality of multiplication circuits is configured to multiply a first integer by a second integer. The addition circuit is configured to collectively add multiplication results of the plurality of multiplication circuits. The remainder circuit is configured to obtain an approximate value of a modulo operation result with a third integer as a modulus with respect to an addition result of the addition circuit. The correction circuit is configured to correct an error of the approximate value.

Exemplary embodiments of a finite field operation device will be explained below in detail with reference to the accompanying drawings. The present invention is not limited to the following embodiments.

### First Embodiment

A finite field operation device according to a first embodiment is a device that performs a finite field operation related to a digital signature. For example, the finite field operation device performs digital signature processing including a finite field operation on firmware of a memory system, and is devised to perform the finite field operation at a high speed.

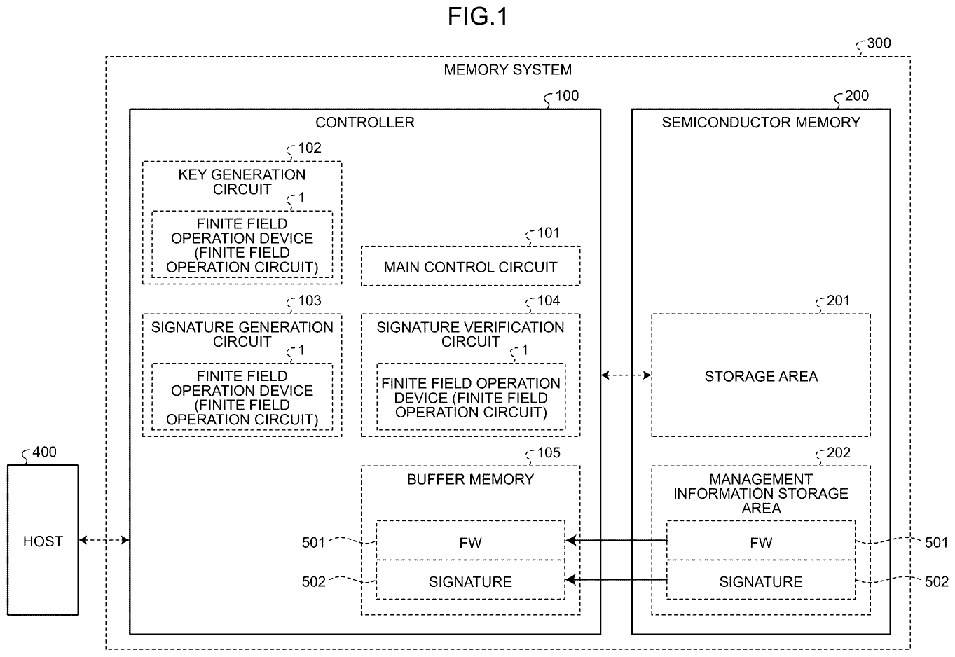

For example, a memory system 300 to which a controller 100 including a finite field operation device 1 is applied is configured as illustrated in FIG. 1. FIG. 1 is a diagram illustrating a configuration of the memory system 300 to which the controller 100 including the finite field operation device 1 is applied.

The memory system 300 is, for example, a solid state drive (SSD). The memory system 300 includes the controller 100 and a semiconductor memory 200.

The controller 100 performs the digital signature processing including a finite field operation on firmware 501 for controlling an operation of the memory system 300. In a digital signature, the controller 100 utilizes three algorithms of a key generation algorithm, a signature generation algorithm, and a signature verification algorithm. The controller 100 performs key generation processing including a finite field operation and generates a pair of a public key and a private key according to the key generation algorithm. The controller 100 receives firmware and the private key, performs signature generation processing including a finite field operation, and generates a signature according to the signature generation algorithm. The controller 100 receives firmware, the public key, and the signature, performs signature verification processing including a finite field operation, and verifies the signature according to the signature verification algorithm.

The controller 100 includes a main control circuit 101, a key generation circuit 102, a signature generation circuit 103, a signature verification circuit 104, and a buffer memory 105. Each of the key generation circuit 102, the signature generation circuit 103, and the signature verification circuit 104 includes the finite field operation device 1. The finite field operation device 1 may be configured as a finite field operation circuit. The semiconductor memory 200 is a nonvolatile semiconductor memory (for example, a NAND flash memory) and includes a storage area 201 and a management information storage area 202. User data may be stored in the storage area 201. The firmware 501 and a signature 502 are stored in the management information storage area 202. The signature 502 is a digital signature. The signature 502 may be generated by the signature generation circuit 103 or may be generated outside the memory system 300.

In the memory system 300, when storing the firmware 501 in the management information storage area 202, the controller 100 temporarily stores the firmware 501 in the buffer memory 105 and performs key generation processing by the key generation circuit 102. In the key generation processing, a pair of a public key and a private key is generated.

For example, the key generation circuit 102 may perform the key generation processing according to a module-lattice-based digital signature (MLDSA) scheme. The generated key includes a pair of a public key and a private key. The key generation circuit 102 generates a secret vector. The key generation circuit 102 includes the finite field operation device 1 and performs a finite field operation on the secret vector by the finite field operation device 1. The key generation circuit 102 generates a pair of a public key and a private key using an operation result.

When storing the firmware 501 in the management information storage area 202, the controller 100 temporarily stores the firmware 501 and the private key in the buffer memory 105 and performs signature generation processing by the signature generation circuit 103. In the signature generation processing, the signature 502 is generated.

For example, the signature generation circuit 103 may perform the signature generation processing according to the MLDSA scheme. The signature generation circuit 103 generates a value based on the private key. The signature generation circuit 103 includes the finite field operation device 1 and performs a finite field operation on the value based on the private key by the finite field operation device 1. The signature generation circuit 103 generates the signature 502 using an operation result.

When activating the firmware 501, the controller 100 temporarily stores the firmware 501 and the signature 502 in the buffer memory 105 and performs signature verification processing of the firmware 501 by the signature verification circuit 104. In the signature verification processing, a hash value of the firmware 501 is obtained, a value based on the public key is extracted from the signature 502, and whether a predetermined condition is satisfied is determined using the hash value of the firmware 501 and the extracted value.

For example, the signature verification circuit 104 may perform the signature verification processing according to the MLDSA scheme. The signature verification circuit 104 obtains a first value and a second value based on the signature 502. The signature verification circuit 104 obtains a hash value of the firmware 501. The signature verification circuit 104 obtains a value based on the public key. The signature verification circuit 104 includes the finite field operation device 1 and performs a finite field operation on the value based on the public key and the first value based on the signature 502 by the finite field operation device 1. The signature verification circuit 104 obtains a first parameter according to an operation result. The signature verification circuit 104 obtains a second parameter using the first parameter and the hash value of the firmware 501. The signature verification circuit 104 determines whether matching between the second value based on the signature 502 and the second parameter is satisfied.

When a predetermined condition is satisfied, the signature verification circuit 104 determines that there is no unauthorized tampering and outputs an approval result. In response, the controller 100 activates the firmware 501 and loads functional modules of the firmware 501, for example, into the buffer memory 105. When the predetermined condition is not satisfied, the signature verification circuit 104 determines there is a possibility of unauthorized tampering and outputs a rejection result. In response, the controller 100 does not activate the firmware 501. As a result, in the memory system 300, unauthorized tampering of the firmware 501 can be detected and prevented during activation.

In the memory system 300, to store the firmware 501 at a high speed, each of the key generation processing and the signature generation processing performed during storage is desired to be performed at a high speed. In the memory system 300, to activate the firmware 501 at a high speed, each of the key generation processing and the signature verification processing performed during activation is desired to be performed at a high speed.

To perform the key generation processing at a high speed, the finite field operation in the key generation processing is desired to be performed at a high speed. To perform the signature generation processing at a high speed, the finite field operation in the signature generation processing is desired to be performed at a high speed. To perform the signature verification processing at a high speed, the finite field operation in the signature verification processing is desired to be performed at a high speed.

The finite field operation includes a product of a matrix and a vector, and when iterative processing is performed multiple times with multi-fold accuracy, an operation cost increases and an operation time tends to be long.

Therefore, in the present embodiment, in the finite field operation device 1, each of a plurality of multiplication units multiplies an integer “a” by an integer “b”, and an addition unit collectively adds multiplication results of the plurality of multiplication units, thereby reducing the number of iterations, resulting in processing at a high speed. The finite field operation device 1 in the key generation circuit 102, the finite field operation device 1 in the signature generation circuit 103, and the finite field operation device 1 in the signature verification circuit 104 may have the same configuration.

For example, the finite field operation device 1 used for the key generation processing receives an input of a matrix

$$A = ( \begin{matrix}{A}_{11} & … & {A}_{1 l} \\ … & {A}_{ij} & … \\ {A}_{k 1} & … & {A}_{kl}\end{matrix} )$$

and a vector

$$B = ( \begin{matrix}{B}_{1} \\ … \\ {B}_{l}\end{matrix} )$$

and calculates a product of the matrix and the vector as in Formula 1.

$$( \begin{matrix}{A}_{11} & … & {A}_{1 l} \\ … & {A}_{ij} & … \\ {A}_{k 1} & … & {A}_{kl}\end{matrix} ) ( \begin{matrix}{B}_{1} \\ … \\ {B}_{l}\end{matrix} ) = ( \begin{matrix}{A}_{1 l} {B}_{1} + {A}_{12} {B}_{2} + ⋯ + {A}_{1 l} {B}_{l} \\ ⋮ \\ {A}_{k 1} {B}_{1} + {A}_{k 2} {B}_{2} + ⋯ + {A}_{kl} {B}_{l}\end{matrix} ) \qquad Formula 1$$

In Formula 1, each of “k” and “l” is any integer of 2 or more. Each term of the vector on the right side of Formula 1 is an n-th order polynomial×an n-th order polynomial on a finite field, and each polynomial may be vectorized by number theoretic transform (NTT) as illustrated in Formula 2. “n” is, for example, 255.

$$NTT ( {A}_{k 1} {B}_{1} + {A}_{k 2} {B}_{2} + ⋯ + {A}_{kl} {B}_{l} ) = \{ ( {a}_{0 , 0} {b}_{0 , 0} , {a}_{0 , 1} {b}_{0 , 1} , … , {a}_{0 , n} {b}_{0 , n} ) + ⋯ + ( {a}_{l , 0} {b}_{l , 0} , {a}_{l , 1} {b}_{l , 1} , … , {a}_{l , n} {b}_{l , n} ) \} mod q = \{ ( {a}_{0 , 0} {b}_{0 , 0} , {a}_{0 , 1} {b}_{0 , 1} , … , {a}_{l - 1 , 0} {b}_{l - 1 , 0} + ⋯ + {a}_{l , 0} {b}_{l , 0} , {a}_{l , 1} {b}_{l , 1} , … , {a}_{l , n} {b}_{l , n} ) \} mod q \qquad Formula 2$$

The last side in Formula 2 can be summarized as Formula 3. Formula 3 represents the calculation content desired to be calculated at a high speed in the present embodiment.

$${\sum }_{i = 1}^{n} {a}_{i} {b}_{i} mod q \qquad Formula 3$$

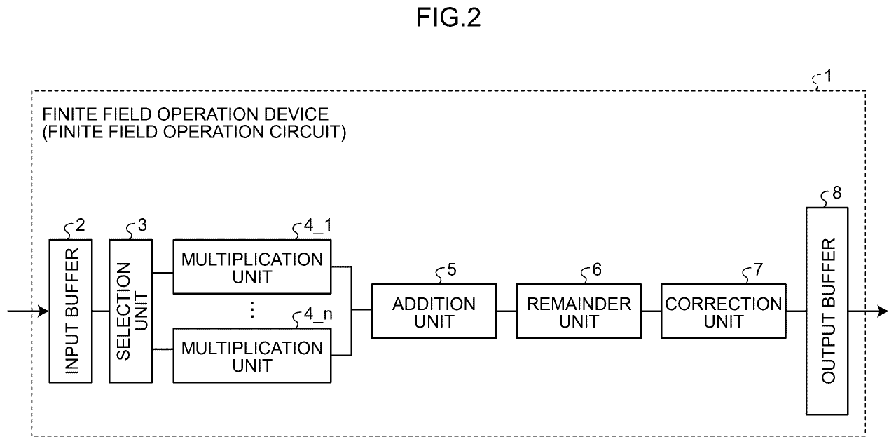

For implementation, the finite field operation device 1 may be configured as illustrated in FIG. 2. FIG. 2 is a circuit diagram illustrating a schematic configuration of the finite field operation device 1.

The finite field operation device 1 includes an input buffer 2, a selection unit 3, a plurality of multiplication units 4_1 to 4_n, an addition unit 5, a remainder unit 6, a correction unit 7, and an output buffer 8. “n” is any integer of 2 or more and indicates the number of multiplication units 4.

In the input buffer 2, an input end is connected to an input node of the finite field operation device 1 and an output end is connected to the selection unit 3. The input buffer 2 receives a pair of integers “a” and “b” as inputs. The input buffer 2 may sequentially receive a plurality of pairs of integers “a” and “b”. The input buffer 2 supplies the pair of integers “a” and “b” to the selection unit 3. The input buffer 2 may sequentially supply the plurality of pairs of integers “a” and “b” to the selection unit 3.

The selection unit 3 is provided between the input buffer 2 and the plurality of multiplication units 4_1 to 4_n. The selection unit 3 selects one of the plurality of multiplication units 4_1 to 4_n and supplies the pair of integers “a” and “b” supplied from the input buffer 2 to the selected multiplication unit 4. The selection unit 3 may sequentially select the plurality of multiplication units 4_1 to 4_n and sequentially supply the plurality of pairs of integers “a” and “b” to the selected multiplication units 4.

The plurality of multiplication units 4_1 to 4_n are provided in parallel between the selection unit 3 and the addition unit 5. In response to supply of the pair of integers “a” and “b” from the selection unit 3, each multiplication unit 4 multiplies the pair of integers “a” and “b” and supplies a multiplication result ab to the addition unit 5.

When the plurality of pairs of integers “a” and “b” are sequentially supplied from the selection unit 3, the plurality of multiplication units 4_1 to 4_n may sequentially multiply a pair of integers aᵢ and bᵢ, and supply a multiplication result aᵢbᵢ to the addition unit 5. Here, i=1 to n.

The addition unit 5 is provided between the plurality of multiplication units 4_1 to 4_n and the remainder unit 6. The addition unit 5 collectively adds the multiplication results of the plurality of multiplication units 4_1 to 4_n. An operation corresponding to Σaᵢbᵢ can be performed by the selection unit 3, the plurality of multiplication units 4_1 to 4_n, and the addition unit 5. The addition unit 5 supplies an addition result Σaᵢbᵢ to the remainder unit 6.

The remainder unit 6 is provided between the addition unit 5 and the correction unit 7. The remainder unit 6 obtains an approximate value of a modulo operation result with an integer “q” as a modulus with respect to the addition result of the addition unit 5. The remainder unit 6 may obtain an approximate value of a modulo operation result with the integer “q” as a modulus by performing Barrett reduction on the addition result of the addition unit 5. The remainder unit 6 supplies the approximate value to the correction unit 7.

The correction unit 7 is provided between the remainder unit 6 and the output buffer 8. The correction unit 7 corrects an error of the approximate value. The correction unit 7 supplies a corrected value to the output buffer 8.

In the output buffer 8, an input end is connected to the correction unit 7 and an output end is connected to an output node of the finite field operation device 1. The output buffer 8 receives the corrected value from the correction unit 7 and outputs the corrected value.

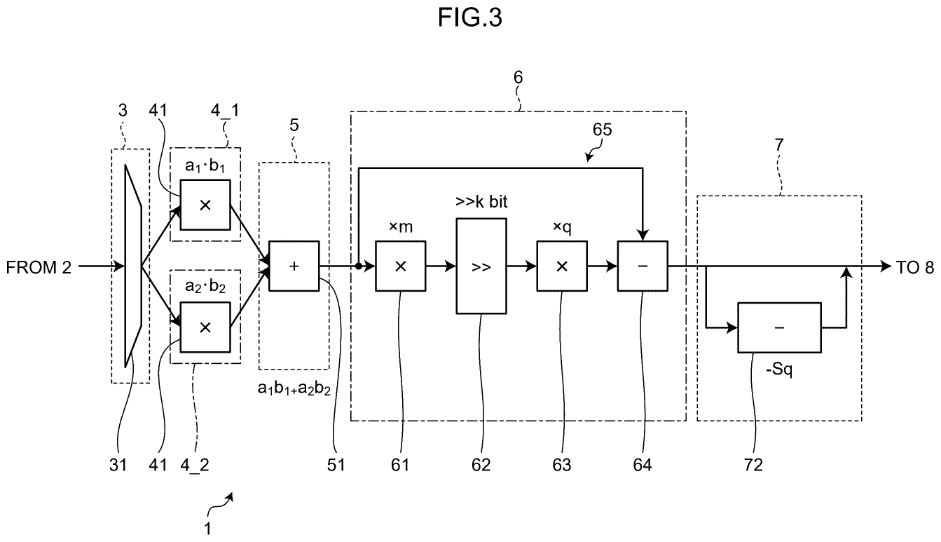

Next, basic calculation contents in the finite field operation device 1 and a detailed configuration of the finite field operation device 1 corresponding thereto are described with reference to FIG. 3. FIG. 3 is a circuit diagram illustrating a detailed configuration of the finite field operation device 1. An example of n=2 for the plurality of multiplication units 4_1 to 4_n is described in FIG. 3.

First, the finite field operation device 1 obtains Σaᵢbᵢ. Here, “i”=1 to 2.

The selection unit 3 illustrated in FIG. 3 includes a selector 31. The selector 31 is connected between the input buffer 2 and the plurality of multiplication units 4_1 and 4_2. The selector 31 receives a pair of integers a₁ and b₁ from the input buffer 2 and receives a pair of integers a₂ and b₂ from the input buffer 2. The selector 31 receives a select signal from outside (for example, a superior controller) and supplies the pair of integers a₁ and b₁ to the multiplication unit 4_1 according to a first value of the select signal. The selector 31 supplies the pair of integers a₂ and b₂ to the multiplication unit 4_2 according to a second value of the select signal.

Each multiplication unit 4 includes a multiplier 41. The multiplier 41 of the multiplication unit 4_1 and the multiplier 41 of the multiplication unit 4_2 are connected in parallel between the selection unit 3 and the addition unit 5. The multiplier 41 of the multiplication unit 4_1 receives the pair of integers a₁ and b₁ from the selection unit 3, performs multiplication by the integer a₁ and the integer b₁, and supplies a multiplication result a₁b₁ to the addition unit 5. The multiplier 41 of the multiplication unit 4_2 receives the pair of integers a₂ and b₂ from the selection unit 3, performs multiplication by the integer a₂ and the integer b₂, and supplies a multiplication result a₂b₂ to the addition unit 5.

Here, multiplication of the integer a₁ and the integer b₁ by the multiplier 41 of the multiplication unit 4_1 and multiplication of the integer a₂ and the integer b₂ by the multiplier 41 of the multiplication unit 4_2 can be performed in parallel. As a result, multiplication of the integer a₁ and the integer b₁ and multiplication of the integer az and the integer b₂ can be efficiently performed.

The addition unit 5 includes an adder 51. The adder 51 is connected between the plurality of multiplication units 4_1 and 4_2 and the remainder unit 6. The adder 51 receives the multiplication result a₁b₁ from the multiplication unit 4_1 and receives the multiplication result a₂b₂ from the multiplication unit 4_2. The adder 51 adds the multiplication result a₁b₁ and the multiplication result a₂b₂. As a result, the addition unit 5 can collectively add the multiplication results of the plurality of multiplication units 4_1 and 4_2.

The addition unit 5 supplies an addition result a₁b₁+a₂b₂ to the remainder unit 6.

Here, the finite field operation device 1 attempts to obtain an integer “z” that is congruent to Σaᵢbᵢ with “q” as a modulus as in Formula 4.

$$z = \sum {a}_{i} {b}_{i} mod q \qquad Formula 4$$

Formula 4 can be rewritten as Formula 5 using the floor function.

$$z = {\sum }_{i = 1}^{n} {a}_{i} {b}_{i} - ⌊ \frac{{\sum }_{i = 1}^{n} {a}_{i} {b}_{i}}{q} ⌋ \cdot q \qquad Formula 5$$

When “q” is not a multiple of 2, since it is difficult to perform an operation using a shift calculator, the finite field operation device 1 performs Barrett reduction. The finite field operation device 1 approximates 1/q≈m/2^{k}. In the approximation, m/2^{k} can be specified by an integer “k” that is the largest integer satisfying

$$1 / q \geq m / {2}^{k} . \qquad Formula 6$$

The value of “m” is given by Formula 7 using the floor function.

$$m = ⌊ \frac{{2}^{k}}{q} ⌋ \qquad Formula 7$$

The finite field operation device 1 approximates Formula 5 as Formula 8 and obtains z′ that is an approximate value of “z”.

$${z}^{′} = {\sum }_{i = 1}^{n} {a}_{i} {b}_{i} - ⌊ \frac{{\sum }_{i = 1}^{n} {a}_{i} {b}_{i} \cdot m}{{2}^{k}} ⌋ \cdot q = {\sum }_{i = 1}^{n} {a}_{i} {b}_{i} - ( ( {\sum }_{i = 1}^{n} {a}_{i} {b}_{i} \cdot m ) >> k ) \cdot q \qquad Formula 8$$

When n=2, Formula 8 can be rewritten as Formula 9.

$${z}^{′} = ( {a}_{1} {b}_{1} + {a}_{2} {b}_{2} ) ( ( ( {a}_{1} {b}_{1} + {a}_{2} {b}_{2} ) \cdot m ) >> k ) \cdot q \qquad Formula 9$$

In Formulas 8 and 9, “.” represents multiplication, “>>” represents a shift operation, and “>>k” represents a k-bit shift operation.

The remainder unit 6 includes a multiplier 61, a shift calculation unit 62, a multiplier 63, a subtractor 64, and a bypass line 65. The multiplier 61 is connected between the addition unit 5 and the shift calculation unit 62. The multiplier 61 performs an operation corresponding to “·m” in Formula 9. The multiplier 61 receives the addition result a₁b₁+a₂b₂ from the addition unit 5, multiplies the addition result a₁b₁+a₂b₂ by m, and supplies a multiplication result (a₁b₁+a₂b₂)·m to the shift calculation unit 62.

The shift calculation unit 62 is connected between the multiplier 61 and the multiplier 63. The shift calculation unit 62 performs an operation corresponding to “>>k” in Formula 9. The shift calculation unit 62 receives the multiplication result (a₁b₁+a₂b₂)·m from the multiplier 61. In the shift calculation unit 62, the left side of a bit string to be calculated is a high-order digit, and the right side thereof is a low-order digit. The shift calculation unit 62 shifts the multiplication result (a₁b₁+a₂b₂)·m to the right by “k” bits. As a result, the shift calculation unit 62 equivalently divides the multiplication result (a₁b₁+a₂b₂)·m by 2^{k}. The shift calculation unit 62 supplies an operation result (a₁b₁+a₂b₂)·m>>k to the multiplier 63.

The multiplier 63 is connected between the shift calculation unit 62 and the subtractor 64. The multiplier 63 performs an operation corresponding to “·q” in Formula 9. The multiplier 63 receives the operation result (a₁b₁+a₂b₂)·m>>k from the shift calculation unit 62, multiplies the operation result (a₁b₁+a₂b₂)·m>>k by “q”, and supplies a multiplication result ((a₁b₁+a₂b₂)·m>>k)·q to the subtractor 64.

The bypass line 65 bypasses the multiplier 61, the shift calculation unit 62, and the multiplier 63, and connects the addition unit 5 to the subtractor 64. In the bypass line 65, a first end is connected to an output end of the addition unit 5, and a second end is connected to an input end of the subtractor 64.

The subtractor 64 is connected between the multiplier 63 and the correction unit 7 and between the addition unit 5 and the correction unit 7. The subtractor 64 performs an operation corresponding to “−(((a₁b₁+a₂b₂)·m)>>k)·q” in Formula 9. The subtractor 64 receives the addition result (a₁b₁+a₂b₂) from the addition unit 5 via the bypass line 65 and receives the multiplication result ((a₁b₁+a₂b₂)·m>>k)·q from the multiplier 63. The subtractor 64 subtracts the multiplication result (((a₁b₁+a₂b₂)·m>>k)·q) from the addition result (a₁b₁+a₂b₂) and supplies a subtraction result (a₁b₁+a₂b₂)−((a₁b₁+a₂b₂)·m>>k)·q to the correction unit 7 as the approximate value z′.

The finite field operation device 1 can obtain an approximation error Δz of z′ with respect to “z” as in Formula 10 from Formulas 5 and 8.

$$Δ z = {z}^{′} - z = ( - ⌊ \frac{{\sum }_{i = 1}^{n} {a}_{i} {b}_{i} \cdot m}{{2}^{k}} ⌋ + ⌊ \frac{{\sum }_{i = 1}^{n} {a}_{i} {b}_{i}}{q} ⌋ ) \cdot q = S \cdot q \qquad Formula 10$$

When n=2, Formula 10 can be rewritten as Formula 11.

$$Δ z = {z}^{′} - z = ( - ⌊ \frac{( {a}_{1} {b}_{1} + {a}_{2} {b}_{2} ) \cdot m}{{2}^{k}} ⌋ + ⌊ \frac{{a}_{1} {b}_{1} + {a}_{2} {b}_{2}}{q} ⌋ ) \cdot q = S \cdot q \qquad Formula 11$$

In Formulas 10 and 11, “S” is any integer of 0 or more. When Formulas 10 and 11 are solved for “z”, Formula 12 is obtained.

$$z = {z}^{′} - S \cdot q \qquad Formula 12$$

As in Formula 12, the finite field operation device 1 can perform an operation corresponding to subtracting the integer “q” from the approximate value z′ “S” times and perform correction to bring the approximate value z′ closer to “z”. The integer “q” is the same as the integer “q” in Formula 5. “S” is the same as the integer “S” in Formulas 10, 11, and 12.

The correction unit 7 includes a subtractor 72. The subtractor 72 performs an operation corresponding to “−S·q” in Formula 12. The subtractor 72 subtracts S·q. As a result, the subtractor 72 can perform an operation corresponding to subtracting the integer “q” from the approximate value z′ “S” times.

Note that the correction unit 7 may include “S” subtractors instead of the subtractor 72. Then, the “S” subtractors are connected in series between the remainder unit 6 and the output buffer 8. Each of the “S” subtractors subtracts “q” from the supplied value. As a result, the “S” subtractors 71_1 to 71_S can perform an operation corresponding to subtracting the integer “q” from the approximate value z′ “S” times.

The correction unit 7 supplies the corrected value “z” to the output buffer 8.

As described above, in the first embodiment, in the finite field operation device 1, each of the plurality of multiplication units 4 (the multipliers 41) multiplies the integer “a” by the integer “b”, and the addition unit 5 (the adder 51) collectively adds the multiplication results of the plurality of multiplication units 4. As a result, the number of iterations of processing can be reduced as compared with a finite field operation such as NTT in which multiplication of the integer “a” and the integer “b” and addition of the multiplication result to the already-added result are alternately performed, so that the overall processing can be performed at a high speed.

Note that, instead of specifying the number of bits “k” of the shift operation as the integer “k” that is the largest integer satisfying Formula 6, when the bit lengths of aᵢ and bᵢ are “1”, the number of multiplication units 4 is “n”, and a value obtained by dividing the approximation error Δz by “q” is “S” (see Formulas 10 and 11), the number of bits “k” of the shift operation may be specified as an integer k satisfying

$$k \geq 21 + {log}_{2} n - {log}_{2} S . \qquad Formula 13$$

When n=2, Formula 13 can be rewritten as Formula 14.

$$k \geq 21 + 1 - {log}_{2} S \qquad Formula 14$$

### Second Embodiment

Next, a finite field operation device according to a second embodiment is described. Hereinafter, differences from the first embodiment are mainly described.

As a configuration of a finite field operation device, a configuration in which a remainder operation is performed in one stage is exemplified in the first embodiment, but a configuration in which a remainder operation is performed in two stages is exemplified in the second embodiment.

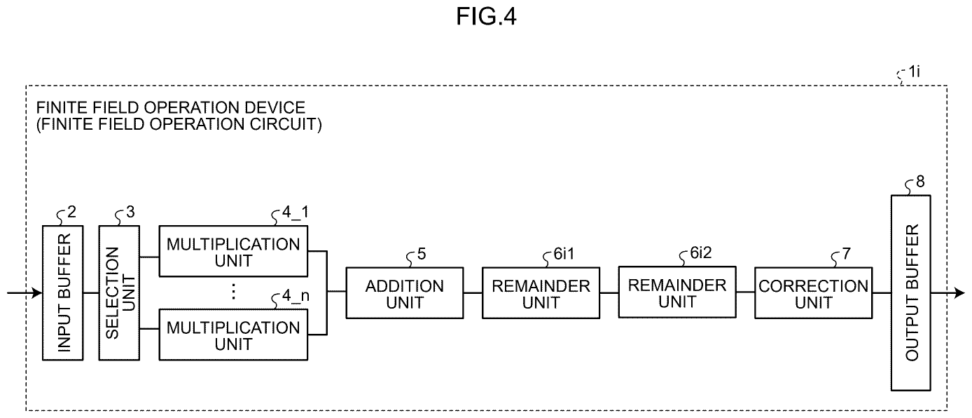

A finite field operation device 1i according to the second embodiment may be configured as illustrated in FIG. 4. FIG. 4 is a circuit diagram illustrating a schematic configuration of the finite field operation device 1i according to the second embodiment.

The finite field operation device 1i includes a remainder unit 6i1 and a remainder unit 6i2 instead of the remainder unit 6 (see FIG. 2).

The remainder unit 6i1 is provided between the addition unit 5 and the remainder unit 6i2. The remainder unit 6i1 performs an operation corresponding to a first half of a processing of obtaining an approximate value of a modulo operation result with the integer “q” as a modulus with respect to the addition result of the addition unit 5. The remainder unit 6i1 may perform the operation corresponding to the first half of the processing of obtaining the approximate value of a modulo operation result with the integer “q” as a modulus by performing Barrett reduction on the addition result of the addition unit 5. The remainder unit 6i1 supplies an operation result to the remainder unit 6i2.

The remainder unit 6i2 is provided between the remainder unit 6i1 and the correction unit 7. The remainder unit 6i2 performs an operation corresponding to a second half of the processing of obtaining the approximate value of a modulo operation result with the integer “q” as a modulus with respect to the operation result of the remainder unit 6i1. The remainder unit 6i2 may perform the operation corresponding to the second half of the processing of obtaining the approximate value of a modulo operation result with the integer “q” as a modulus by performing Barrett reduction on the operation result of the remainder 6i1 that is based on the addition result of the addition unit 5. The remainder unit 6i2 supplies an approximate value obtained by the operation to the correction unit 7.

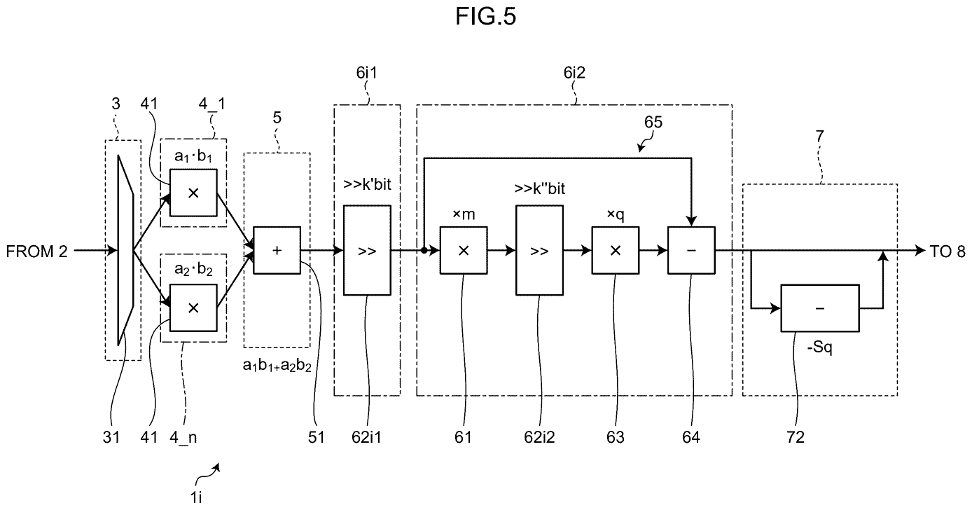

Basic calculation contents in the finite field operation device 1i and a detailed configuration of the finite field operation device 1i corresponding thereto are different from those of the first embodiment in the following points as illustrated in FIG. 5. FIG. 5 is a circuit diagram illustrating a detailed configuration of the finite field operation device 1i according to the second embodiment. An example of n=2 for the plurality of multiplication units 4_1 to 4_n is described in FIG. 5.

When “q” is not a multiple of 2, since it is difficult to perform an operation using a shift calculator, the finite field operation device 1i performs Barrett reduction. The finite field operation device 1i approximates 1/q≈m/2^{k′+k″}. In the approximation, m/2^{k′+k″} can be specified by an integer k′+k″ that is the largest integer satisfying

$$1 / q \geq m / {2}^{{k}^{′} + {k}^{″}} . \qquad Formula 15$$

The value of “m” is given by Formula 16 using the floor function.

$$m = ⌊ \frac{{2}^{{k}^{′} + {k}^{″}}}{q} ⌋ \qquad Formula 16$$

The finite field operation device 1i approximates Formula 5 as Formula 17 and obtains z′ that is an approximate value of “z”.

$$Z ′ = {\sum }_{i = 1}^{n} {a}_{i} {b}_{i} - ⌊ \frac{⌊ \frac{{\sum }_{i = 1}^{n} {a}_{i} {b}_{i}}{{2}^{{k}^{′}}} ⌋ \cdot m}{{2}^{{k}^{″}}} ⌋ \cdot q = {\sum }_{i = 1}^{n} {a}_{i} {b}_{i} - ( ( ( {\sum }_{i = 1}^{n} {a}_{i} {b}_{i} >> {k}^{′} ) \cdot m ) >> {k}^{″} ) \cdot q \qquad Formula 17$$

When n=2, Formula 17 can be rewritten as Formula 18.

$${z}^{′} = ( {a}_{1} {b}_{1} + {a}_{2} {b}_{2} ) - ( ( ( ( {a}_{1} {b}_{1} + {a}_{2} {b}_{2} ) >> {k}^{′} ) \cdot m ) >> {k}^{″} ) \cdot q \qquad Formula 18$$

In Formulas 17 and 18, “.” represents multiplication, “>>” represents a shift operation, “>>k′” represents a shift operation of k′ bits, and “>>k″” represents a shift operation of k″ bits.

The remainder unit 6i1 includes a shift calculation unit 62i1.

The shift calculation unit 62i1 is connected between the addition unit 5 and the remainder unit 6i2. The shift calculation unit 62i1 performs an operation corresponding to “>>k′” in Formula 18. The shift calculation unit 62i1 receives the addition result (a₁b₁+a₂b₂) from the addition unit 5. In the shift calculation unit 62i1, the left side of a bit string to be calculated is a high-order digit, and the right side thereof is a low-order digit. The shift calculation unit 62i1 shifts the addition result (a₁b₁+a₂b₂) to the right by k′ bits. As a result, the shift calculation unit 62i1 equivalently divides the addition result (a₁b₁+a₂b₂) by 2^{k}′. The shift calculation unit 62i1 supplies an operation result (a₁b₁+a₂b₂)>>k′ to the remainder unit 6i2.

The remainder unit 6i2 includes the multiplier 61, a shift calculation unit 62i2, the multiplier 63, the subtractor 64, and the bypass line 65. The multiplier 61 is connected between the remainder unit 6i1 and the shift calculation unit 62i2. The multiplier 61 performs an operation corresponding to “·m” in Formula 18. The multiplier 61 receives the operation result (a₁b₁+a₂b₂)>>k′ from the remainder unit 6i1, multiplies the operation result (a₁b₁+a₂b₂)>>k′ by “m”, and supplies a multiplication result ((a₁b₁+a₂b₂)>>k′)·m to the shift calculation unit 62i2.

The shift calculation unit 62i2 is connected between the multiplier 61 and the multiplier 63. The shift calculation unit 62i2 performs an operation corresponding to “>>k″” in Formula 18. The shift calculation unit 62i2 receives the multiplication result ((a₁b₁+a₂b₂)>>k′)·m from the multiplier 61. In the shift calculation unit 62i2, the left side of a bit string to be calculated is a high-order digit, and the right side thereof is a low-order digit. The shift calculation unit 62i2 shifts the multiplication result ((a₁b₁+a₂b₂)>>k′)·m to the right by k″ bits. As a result, the shift calculation unit 62i2 equivalently divides the addition result ((a₁b₁+a₂b₂)>>k′)·m by 2^{k}″. The shift calculation unit 62i2 supplies an operation result (((a₁b₁+a₂b₂)>>k′)·m)>>k″ to the multiplier 63.

The multiplier 63 is connected between the shift calculation unit 62i2 and the subtractor 64. The multiplier 63 performs an operation corresponding to “·q” in Formula 18. The multiplier 63 receives the operation result (((a₁b₁+a₂b₂)>>k′)·m)>>k″ from the shift calculation unit 62i2, multiplies the operation result (((a₁b₁+a₂b₂)>>k′)·m)>>k″ by “q”, and supplies a multiplication result ((((a₁b₁+a₂b₂)>>k′)·m)>>k″)·q to the subtractor 64.

The bypass line 65 bypasses the multiplier 61, the shift calculation unit 62i2, and the multiplier 63, and connects the remainder unit 6i1 to the subtractor 64. In the bypass line 65, a first end is connected to an output end of the remainder unit 6i1, and a second end is connected to an input end of the subtractor 64.

The subtractor 64 is connected between the multiplier 63 and the correction unit 7 and between the remainder unit 6i1 and the correction unit 7. The subtractor 64 performs an operation corresponding to “−((((a₁b₁+a₂b₂)>>k′)·m)>>k″)·q″ in Formula 18. The subtractor 64 receives the operation result (a₁b₁+a₂b₂)>>k′ from the remainder unit 6i1 via the bypass line 65 and receives the multiplication result ((((a₁b₁+a₂b₂)>>k′)·m)>>k″)·q from the multiplier 63. The subtractor 64 subtracts the multiplication result (((((a₁b₁+a₂b₂)>>k′)·m)>>k″)·q from the operation result (a₁b₁+a₂b₂)>>k′ and supplies a subtraction result (a₁b₁+a₂b₂)>>k′−((((a₁b₁+a₂b₂)>>k′)·m)>>k″)·q to the correction unit 7 as the approximate value z′.

Since the shift operation is performed divided into two operations in the finite field operation device 1i, each of the numbers of bits k′ and k″ of the shift operation is prevented from being larger than the number of bits “k” of the shift operation of the first embodiment. As a result, a bit width of the value supplied from the shift calculation unit 62i1 to the multiplier 61 can be prevented from being larger, and a bit width of the value supplied from the shift calculation unit 62i2 to the multiplier 63 can be prevented from being larger. As a result, a size of the multiplier 61 can be reduced, and a size of the multiplier 63 can be reduced.

As described above, in the second embodiment, in the finite field operation device 1i, the remainder operation is performed in two stages of the operation by the remainder unit 6i1 and the operation by the remainder unit 6i2. As a result, the size of the multiplier 61 in the remainder unit 6i2 can be reduced, and the size of the multiplier 63 can be reduced. Therefore, a circuit area of the finite field operation device 1i can be easily reduced, and thus a cost of the finite field operation device 1i can be reduced.

Note that, instead of specifying each number of bits k′ and k″ of the shift operation as the integer k′+k″ that is the largest integer satisfying Formula 15, when bit lengths of aᵢ and bᵢ are “l”, the number of multiplication units 4 is “n”, a value obtained by dividing the approximation error Δz by “q” is “S” (see Formulas 10 and 11), and a real number satisfying 0<α<1 is “α”, the numbers of bits k′ and k″ of the shift operation may be specified as integers k′ and k″ satisfying

$${k}^{′} + {k}^{″} \geq 21 + {log}_{2} n - {log}_{2} α S \qquad Formula 19$$

prevented from

$${k}^{′} \leq ( 1 - 1 ) + {log}_{2} ( ( 1 - α ) S ) . \qquad Formula 20$$

When n=2, Formula 19 can be rewritten as Formula 21.

$${k}^{′} + {k}^{″} \geq 21 + 1 - {log}_{2} α S \qquad Formula 21$$

### Third Embodiment

Next, a finite field operation device according to a third embodiment is described. Hereinafter, differences from the first and second embodiments are mainly described.

As a configuration of a finite field operation device, a configuration in which addition of the multiplication results of the plurality of multiplication units 4 is collectively performed by the addition unit 5 is exemplified in the first embodiment and the second embodiment, but a configuration in which addition of a part of the multiplication results of the plurality of multiplication units and subtraction of another part are collectively performed by an addition/subtraction unit 5j is exemplified in the third embodiment.

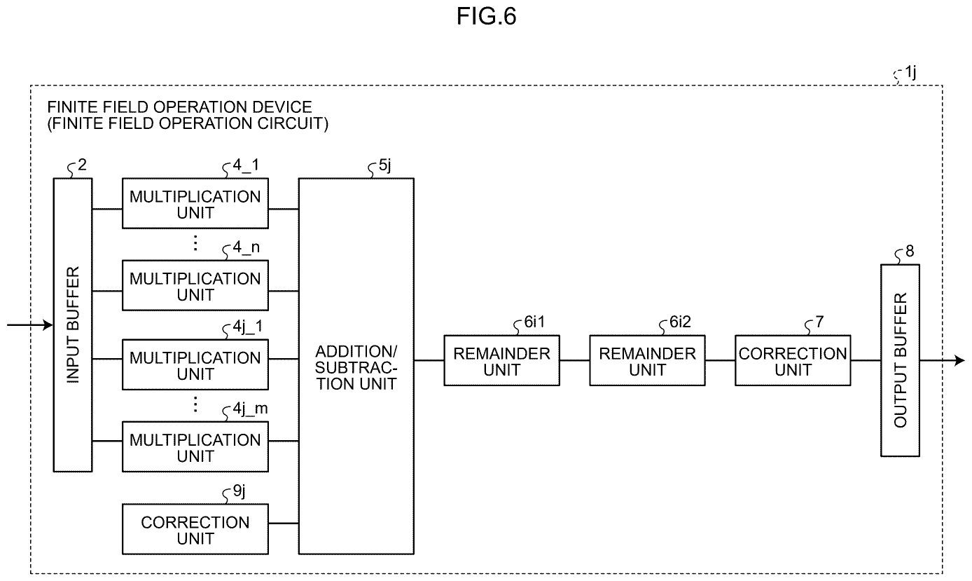

A finite field operation device 1j according to the third embodiment may be configured as illustrated in FIG. 6. FIG. 6 is a circuit diagram illustrating a schematic configuration of the finite field operation device 1j according to the third embodiment.

In the finite field operation device 1j, the selection unit 3 is omitted, a plurality of multiplication units 4j_1 to 4j_m and a correction unit 9j are added, and the addition unit 5 is replaced with the addition/subtraction unit 5j compared to the finite field operation device 1i (see FIG. 4).

The plurality of multiplication units 4_1 to 4_n and the plurality of multiplication units 4j_1 to 4j_m are provided in parallel between the input buffer 2 and the addition/subtraction unit 5j.

In response to supply of the pair of integers “a” and “b” from the input buffer 2, each multiplication unit 4 multiplies the pair of integers “a” and “b” and supplies a multiplication result ab to the addition/subtraction unit 5j.

In response to supply of a pair of integers “c” and “d” from the input buffer 2, each multiplication unit 4j multiplies the pair of integers “c” and “d” and supplies a multiplication result cd to the addition/subtraction unit 5j.

The addition/subtraction unit 5j is provided between the plurality of multiplication units 4_1 to 4_n and 4j_1 to 4j_m and the remainder unit 6i1. The addition/subtraction unit 5j collectively adds the multiplication results of the “n” multiplication units 4_1 to 4_n and collectively subtracts the multiplication results of the “m” multiplication units 4j_1 to 4j_m. The plurality of multiplication units 4_1 to 4_n and 4j_1 to 4j_m and the addition/subtraction unit 5j can perform an operation corresponding to Σaᵢbᵢ−Σcⱼdⱼ. Here, i=1 to n is satisfied for the integer “a” and the integer “b”, and j=1 to m is satisfied for the integer “c” and the integer “d”.

Note that, in the addition/subtraction unit 5j, a negative value may be obtained when a subtracted number is smaller than a subtracting number. Before Barrett reduction is performed by the remainder units 6i1 and 6i2 using a property of the finite field that a mod q=a+q mod q, it is possible to add X that is a multiple of “q” to the subtracted number so that a positive number is obtained.

Therefore, the correction unit 9j is connected to an input end of the addition/subtraction unit 5j. The correction unit 9j can supply 0 or X that is a multiple of “q” to the addition/subtraction unit 5j as a correction value. X can be set to a multiple of “q” satisfying

$$0 < X \leq m \cdot {q}^{2}$$

$$and$$

$$\sum {c}_{j} {d}_{j} \leq X for j = 1 to m .$$

In a first case, the correction unit 9j supplies 0 to the addition/subtraction unit 5j.

In a second case, the correction unit 9j supplies X that is a multiple of “q” to the addition/subtraction unit 5j.

Note that contents of each of the first case and the second case can be freely determined according to the specification required for the finite field operation device 1j.

As a result, the addition/subtraction unit 5j can collectively perform addition of the multiplication results of the “n” multiplication units 4_1 to 4_n, subtraction of the multiplication results of the “m” multiplication units 4j_1 to 4j_m, and addition of 0 or X (correction value) that is a multiple of “q” so that a positive addition/subtraction result is obtained.

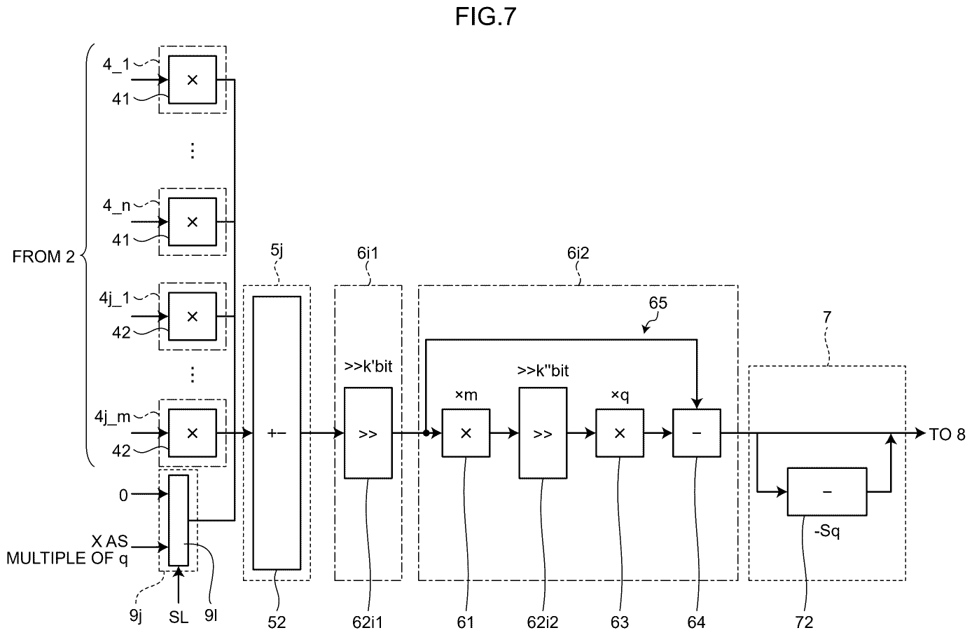

Basic calculation contents in the finite field operation device 1j and a detailed configuration of the finite field operation device 1j corresponding thereto are different from those of the first embodiment in the following points as illustrated in FIG. 7. FIG. 7 is a circuit diagram illustrating a detailed configuration of the finite field operation device 1j according to the third embodiment.

The finite field operation device 1j first obtains Σaᵢbᵢ−Σcⱼdⱼ.

Each multiplication unit 4 illustrated in FIG. 7 includes the multiplier 41. The multipliers 41 of the plurality of multiplication units 4_1 to 4_n are connected in parallel between the input buffer 2 and the addition/subtraction unit 5j. The multiplier 41 receives a pair of the integers aᵢ and bᵢ from the input buffer 2, multiplies the integer aᵢ by the integer bᵢ, and supplies a multiplication result aᵢbᵢ to the addition/subtraction unit 5j.

That is, the multiplier 41 of each of the plurality of multiplication units 4_1 to 4_n supplies a multiplication result Σaᵢbᵢ to the addition/subtraction unit 5j.

Each multiplication unit 4j includes a multiplier 42. The multipliers 42 of the plurality of multiplication units 4j_1 to 4j_m are connected in parallel between the input buffer 2 and the addition/subtraction unit 5j. The multiplier 42 receives a pair of the integers cⱼ and dⱼ from the input buffer 2, multiplies the integer cⱼ by the integer dⱼ, and supplies a multiplication result cⱼdⱼ to the addition/subtraction unit 5j.

That is, the multiplier 42 of each of the plurality of multiplication units 4j_1 to 4j_m supplies a multiplication result Σcⱼdⱼ to the addition/subtraction unit 5j.

The correction unit 9j includes a selector 91. The selector 91 includes a first input node that receives 0, a second input node that receives X that is a multiple of “q”, a control node that receives a select signal SL from outside (superior controller), and an output node connected to the input end of the addition/subtraction unit 5j.

In the first case, the selector 91 receives the first value as the select signal SL, selects the first input node, and supplies 0 to the addition/subtraction unit 5j.

As a result, the addition/subtraction unit 5j can collectively perform addition of the multiplication results of the n multiplication units 4_1 to 4_n and subtraction of the multiplication results of the m multiplication units 4j_1 to 4j_m so that an addition/subtraction result Σaᵢbᵢ−Σcⱼdⱼ is obtained.

In the second case, the selector 91 receives the second value as the select signal SL, selects the second input node, and supplies X that is a multiple of “q” to the addition/subtraction unit 5j.

As a result, the addition/subtraction unit 5j collectively performs addition of the multiplication results of the n multiplication units 4_1 to 4_n, subtraction of the multiplication results of the m multiplication units 4j_1 to 4j_m, and addition of X that is a multiple of “q” so that a positive addition/subtraction result Σaᵢbᵢ−Σcⱼdⱼ+X is obtained.

As described above, in the third embodiment, in the finite field operation device 1j, each of the plurality of multiplication units 4 (the multipliers 41) multiplies the integer “a” by the integer “b”, each of the plurality of multiplication units 4j (the multipliers 42) multiplies the integer “c” and the integer “d”, and the addition unit 5 collectively performs addition of the multiplication results of the plurality of multiplication units 4 and subtraction of the multiplication results of the plurality of multiplication units 4j. Accordingly, also here, the number of iterations of processing can be reduced as compared with a finite field operation such as NTT in which multiplication of the integer “a” and the integer “b”, multiplication of the integer “c” and the integer “d”, and addition/subtraction of each multiplication result to/from the already-added/subtracted result are alternately performed, so that the overall processing can be performed at a high speed.

### Fourth Embodiment

Next, a finite field operation device 1 according to a fourth embodiment is described. Hereinafter, differences from the first to third embodiments are mainly described.

A configuration in which processing in the finite field operation device is performed at a high speed is exemplified in the first to third embodiments, and key generation processing to which the configuration is to be applied is exemplified in the fourth embodiment.

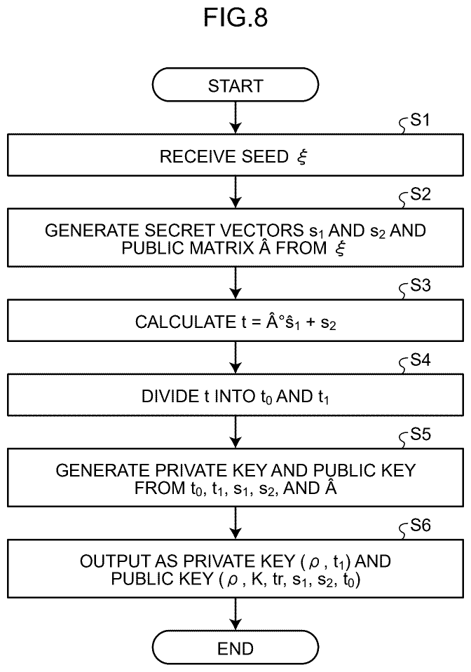

For example, the finite field operation devices 1, 1i, and 1j according to the first to third embodiments may be applied to key generation processing as illustrated in FIG. 8. FIG. 8 is a flowchart illustrating key generation processing according to the fourth embodiment. The flowchart illustrated in FIG. 8 may be executed by the key generation circuit 102 illustrated in FIG. 1. The key generation circuit 102 includes any one of the finite field operation devices 1, 1i, and 1j according to the first to third embodiments.

When the key generation processing starts, the key generation circuit 102 receives a seed ξ (S1) and generates secret vectors s₁ and s₂ and a public matrix A\hat{ } from the seed ξ (S2).

The finite field operation device 1 of the key generation circuit 102 calculates t=A\hat{ }s₁\hat{ }+s₂ (S3). A configuration in which processing is performed at a high speed exemplified in the first to third embodiments is applied to the calculation.

The key generation circuit 102 divides t into t0 and t1 (S4).

The key generation circuit 102 generates a private key and a public key from t0, t1, s1, s2, and A\hat{ } (S5).

The key generation circuit 102 outputs a private key (ρ, t1) and a public key (ρ, K, tr, s1, s2, t0) (S6).

As described above, in the fourth embodiment, a configuration in which the processing is performed at a high speed is applied to the key generation processing in the finite field operation device 1 in the key generation circuit 102 so that the key generation processing can be performed at a high speed.

Note that, as a first modification of the fourth embodiment, a configuration in which the processing is performed at a high speed may be applied to signature generation processing.

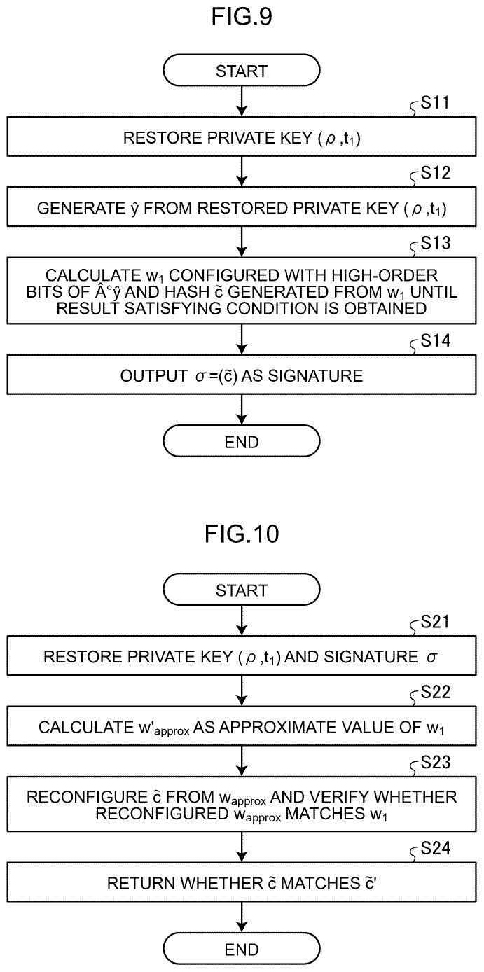

For example, the finite field operation devices 1, 1i, and 1j according to the first to third embodiments may be applied to signature generation processing as illustrated in FIG. 9. FIG. 9 is a flowchart illustrating signature generation processing in the first modification of the fourth embodiment. The flowchart illustrated in FIG. 9 may be executed by the signature generation circuit 103 illustrated in FIG. 1. The signature generation circuit 103 includes any one of the finite field operation devices 1, 1i, and 1j according to the first to third embodiments.

When the signature generation processing starts, the signature generation circuit 103 restores the private key (ρ, t1) (S11).

The signature generation circuit 103 generates y\hat{ } from the restored private key (ρ, t1) (S12).

The finite field operation device 1 of the signature generation circuit 103 calculates w1 configured with high-order bits of A\hat{ }·y\hat{ } and a hash c\hat{ } generated from w1 until a result satisfying the condition is obtained (S13). A configuration in which processing is performed at a high speed exemplified in the first to third embodiments is applied to the calculation.

The signature generation circuit 103 outputs σ=(c~) as a signature (S14).

As such, a configuration in which the processing is performed at a high speed is applied to the signature generation processing in the finite field operation device 1 in the signature generation circuit 103 so that the signature generation processing can be performed at a high speed.

Otherwise, as a second modification of the fourth embodiment, a configuration in which the processing is performed at a high speed may be applied to signature verification processing.

For example, the finite field operation devices 1, 1i, and 1j according to the first to third embodiments may be applied to signature verification processing as illustrated in FIG. 10. FIG. 10 is a flowchart illustrating signature verification processing in the second modification of the fourth embodiment. The flowchart illustrated in FIG. 10 may be executed by the signature verification circuit 104 illustrated in FIG. 1. The signature verification circuit 104 includes any one of the finite field operation devices 1, 1i, and 1j according to the first to third embodiments.

When the signature verification processing starts, the signature verification circuit 104 restores the private key (ρ, t1) and the signature σ (S21).

The finite field operation device 1 of the signature verification circuit 104 calculates w′ approx that is an approximate value of w1 (S22). A configuration in which processing is performed at a high speed exemplified in the first to third embodiments is applied to the calculation.

The signature verification circuit 104 reconfigures c~ from wapprox and verifies whether reconfigured wapprox matches w1 (S23).

The signature verification circuit 104 returns whether c~ matches c~′ (S24).

As such, a configuration in which the processing performed at a high speed is applied to the signature verification processing in the finite field operation device 1 in the signature verification circuit 104 so that the signature verification processing can be performed at a high speed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A finite field operation device comprising:
a plurality of multiplication circuits configured to each multiply a first integer by a second integer;
an addition circuit configured to collectively add multiplication results of the plurality of multiplication circuits;
a remainder circuit configured to obtain an approximate value of a modulo operation result with a third integer as a modulus with respect to an addition result of the addition circuit; and
a correction circuit configured to correct an error of the approximate value.

2. The finite field operation device according to claim 1, wherein
the plurality of multiplication circuits is configured to perform the multiplications in parallel.

3. The finite field operation device according to claim 1, wherein
the remainder circuit is configured to perform Barrett reduction on the addition result of the addition circuit to obtain the approximate value.

4. The finite field operation device according to claim 3, wherein,
when the third integer is q, and k is any integer of 1 or more, the remainder circuit is configured to multiply the addition result of the addition circuit by m that is a value based on q and k, perform a shift operation by k bits, multiply a result by q, and subtract the multiplication result from the addition result of the addition circuit to obtain the approximate value.

5. The finite field operation device according to claim 4, wherein
m/2^{k} is defined by k that is a largest integer satisfying
$$1 / q \geq m / {2}^{k}$$
and
m is defined by
$$m = ⌊ \frac{{2}^{k}}{q} ⌋ .$$

6. The finite field operation device according to claim 4, wherein,
when a bit length of each of the first integer and the second integer is l, the number of the multiplication circuits is n, and a value obtained by dividing the error by the third integer is S, k is defined as an integer satisfying
$$k \geq 21 + {log}_{2} n - {log}_{2} S$$
and
m is defined by
$$m = ⌊ \frac{{2}^{k}}{q} ⌋ .$$

7. The finite field operation device according to claim 1, wherein
the remainder circuit includes
a first remainder circuit configured to perform a first operation on the addition result of the addition circuit, and
second remainder circuit configured to perform a second operation on a result of the first operation.

8. The finite field operation device according to claim 7, wherein
when k′ is any integer of 1 or more, the first remainder circuit is configured to perform a shift operation by k′ bits, and
when the third integer is q, and k″ is any integer of 1 or more, the second remainder circuit is configured to multiply a result of the first operation by m that is a value based on q, k′ and k″, perform a shift operation by k″ bits, multiply a result by q, and subtract the multiplication result from the result of the first operation to obtain the approximate value as a result of the second operation.

9. The finite field operation device according to claim 8, wherein m/2^{k′+k″} is defined by k′+k″ that is a largest integer satisfying
$$1 / q \geq m / {2}^{k ′ + k ′}$$
and
m is defined by
$$m = ⌊ \frac{{2}^{{k}^{′} + {k}^{″}}}{q} ⌋ .$$

10. The finite field operation device according to claim 8, wherein, when a bit length of each of the first integer and the second integer is l, the number of the multiplication circuits is n, a value obtained by dividing the error by the third integer is S, and a real number satisfying 0<α<1 is α, k′ and k″ are defined as integers satisfying
$${k}^{′} + {k}^{″} \geq 21 + {log}_{2} n - {log}_{2} α S$$
$$and$$
$${k}^{′} \leq ( 1 - 1 ) + {log}_{2} ( ( 1 - α ) S )$$
and
m is defined by
$$m = ⌊ \frac{{2}^{{k}^{′} + {k}^{″}}}{q} ⌋ .$$

11. The finite field operation device according to claim 1, wherein
the remainder circuit is configured to obtain the approximate value of which approximate error is 0 or more and a fourth integer or less, and
the correction circuit is configured to perform an operation corresponding to subtracting the third integer from the approximate value for a number of times equal to the fourth integer.

12. A finite field operation device comprising:
a plurality of multiplication circuits configured to each multiply a first integer by a second integer;
a first correction circuit configured to generate a correction value;
an addition/subtraction circuit configured to collectively perform addition of a part of multiplication results of the plurality of multiplication circuits, subtraction of another part of multiplication results of the plurality of multiplication circuits, and addition of the correction value;
a remainder circuit configured to obtain an approximate value of a modulo operation result with a third integer as a modulus with respect to an addition/subtraction result of the addition/subtraction circuit; and
a second correction circuit configured to correct an error of the approximate value.

13. The finite field operation device according to claim 12, wherein
the plurality of multiplication circuits is configured to perform the multiplication in parallel.

14. The finite field operation device according to claim 12, wherein
the remainder circuit is configured to perform Barrett reduction on the addition/subtraction result of the addition/subtraction circuit to obtain the approximate value.

15. The finite field operation device according to claim 12, wherein
the remainder circuit includes
a first remainder circuit configured to perform a first operation on the addition/subtraction result of the addition/subtraction circuit, and
a second remainder circuit configured to perform a second operation on a result of the first operation.

16. The finite field operation device according to claim 12, wherein
the remainder circuit is configured to obtain the approximate value of which approximate error is 0 or more and a fourth integer or less, and
the second correction circuit is configured to perform an operation corresponding to subtracting the third integer from the approximate value for a number of times equal to the fourth integer.

17. A memory system comprising:
a memory configured to store firmware; and
a controller that includes the finite field operation device according to claim 1 and configured to perform key generation processing including an operation by the finite field operation device when writing the firmware into the memory.

18. A memory system comprising:
a memory configured to store firmware; and
a controller that includes the finite field operation device according to claim 1, and configured to perform signature generation processing including an operation by the finite field operation device when writing the firmware into the memory, or perform signature verification processing including an operation by the finite field operation device when reading the firmware from the memory.

19. A memory system comprising:
a memory configured to store firmware; and
a controller that includes the finite field operation device according to claim 12 and configured to perform key generation processing including an operation by the finite field operation device when writing the firmware into the memory.

20. A memory system comprising:
a memory configured to store firmware; and
a controller that includes the finite field operation device according to claim 12 and configured to perform signature generation processing including an operation by the finite field operation device when writing the firmware into the memory, or perform signature verification processing including an operation by the finite field operation device when reading the firmware from the memory.
